(19) United States
(12) Patent Application Publication
(10) Pub. No.: US 2020/0124116 A1
(43) Pub. Date: Apr. 23, 2020

(54) CLUTCH ASSEMBLY, IN PARTICULAR FOR MOTORCYCLES, AND TRANSMISSION SYSTEM EQUIPPED WITH SAID CLUTCH ASSEMBLY

(71) Applicant: QOODER S.A., VACALLO (CH)

(72) Inventors: Marco MORONI, MARNATE (IT); Riccardo MARABESE, GALLARATE (IT)

(21) Appl. No.: 16/624,610

(22) PCT Filed: Jun. 20, 2018
(86) PCT No.: PCT/EP2018/066425

§ 371 Date: Dec. 19, 2019

(30) Foreign Application Priority Data
Jun. 20, 2017 (IT) 102017000068135

(51) Int. Cl. F16D 43/14

(52) U.S. Cl. CPC F16D 43/14

(57) ABSTRACT

A clutch comprises a bell alternatively engaged and disengaged by a rotating transmission component, wherein mutual engagement of the bell and the rotating transmission component by first engagement elements results in the bell being dragged in rotation by the transmission component in a first rotation direction, wherein the bell defines an engagement profile formed so as to be alternatively engaged and disengaged by second engagement elements dragged in rotation by the transmission component, and wherein mutual engagement of the second engagement elements and the engagement profile is a result of both the rotation of the transmission component in a second rotation direction, opposite to the first rotation direction, and the rotation of the bell in the first rotation direction. Mutual disengagement of the second engagement elements and the engagement profile is a result of both the rotation of the transmission component in the first rotation direction opposite to the second rotation direction, and the rotation of the bell in the second rotation direction.

### CROSS-REFERENCE TO RELATED APPLICATIONS

This application is a U.S. National Phase filing of PCT International Patent Application No. PCT/EP2018/066425, having an international filing date of Jun. 20, 2018, which claims priority to Italian Patent Application No. 102017000068135, filed Jun. 20, 2017 each of which is hereby incorporated by reference in its entirety.

### FIELD OF THE INVENTION

The present disclosure relates to an innovative clutch, in particular but not exclusively, for motorcycles with two, three and four wheels, scooters, quads and similar vehicles. In particular, the present disclosure relates to a clutch assembly, particularly but not exclusively, adapted to be used in transmission systems for vehicles of the aforesaid type, in particular in transmission systems with automatic variation of the speed, in particular of the transmission ratio. The present disclosure further relates to a transmission system, in particular but not exclusively, with automatic transmission ratio variation, e.g. a CVT (Continuously Variable Transmission).

### BACKGROUND OF THE INVENTION

The use of transmission systems with automatic transmission ratio variation is widespread in the field of motorcycles, in particular of motorcycles with two, three and four wheels, of scooters, quads and similar vehicles. In the field of motorcycles of the aforesaid type, the use of continuously variable transmissions or CVTs is very popular and appreciated by users.

With reference to FIG. 1, the operation of a continuously variable transmission CVT can be summarized as follows.

The rotation of the drive shaft 11 deriving from the action of the engine 10, results in the rotation of the drive pulley 12 (keyed onto the drive shaft 11) and of the driven pulley 13, the latter put into rotation by the drive belt 14, engaged both on the drive pulley 12 and the driven pulley 13. FIG. 1 shows a situation in which the gear ratio (i.e. the ratio between the circumference of the drive pulley 12 and that of the driven pulley 13) is minimum and corresponds to the shortest “gear”. The situation in FIG. 1 occurs with the engine 10 off or idling slowly.

The drive pulley 12 also comprises a fixed half-pulley 15 (rigidly fixed to the drive shaft 11) and a movable half-pulley 16, in particular translatable along the drive shaft 11. A containment cap 17, which is also fixed, defines a space or housing with the movable half-pulley 16, in which “expansion” rollers 18, in variable number according to requirements and/or circumstances, are housed. The rollers 18 can translate in radial direction, perpendicularly to the shaft 11. The outward translation of the rollers 18 away from the shaft 11 occurs by virtue of the action of the centrifugal force exerted on said rollers when a predetermined rotation speed of the shaft 11 and of the pulley 12 is reached, said speed being higher than the one corresponding to the idling speed of the engine 10. The outward translation of the rollers 18 results in a push on the half-pulley 16, which is thus translated along the drive shaft 11 (from the right leftwards with respect to FIG. 1), whereby the rolling circumference of the belt 14 is varied (increased) on the two opposite half-pulleys 15 and 16 with conical surfaces. In practice, the belt 14 “moves up” towards the outside in the pulley 12.

The driven pulley 13 also consists of a fixed half-pulley 19 and a movable half-pulley 20 translatable along the respective rotation shaft 21. The half-pulley 20 thus moves gradually away from the half-pulley 19 as the rotation speed of the shaft 21 increases, thus decreasing the rolling circumference of the belt 14 on the half-pulleys 19 and 20; in practice, the belt 14 progressively “moves down” into the groove defined by the two mutually opposite half-pulleys 19 and 20 with conical surfaces. The maximum transmission ratio, corresponding to the longest gear, occurs with the belt positioned on the maximum rolling circumference of the pulley 12 and on the minimum rolling circumference of the pulley 13. The translation of the half-pulley 20 away from the half-pulley 19 occurs against the elastic bias of the spring 22, whereby the semi pulley 20 is approached to the half pulley 19 by the spring 22 (the half-pulley 21 is translated in the opposite direction, i.e. from the left rightwards with respect to FIG. 1) as the rotation speed of the shaft 21 decreases (as a result of the reduction of rpm of the motor 10 and thus of the rotation speed of the drive shaft 11 and of the pulley 12). At the same time, the rollers 18 also retract towards the shaft 11, whereby the half-pulley 16 moves away again from half-pulley 15 (i.e. translates on the shaft 11 from the left rightwards with respect to FIG. 1).

The transmissions of the type described above with reference to FIG. 1 allow a continual, automatic variation of the gear ratio, by automatically and continuously modifying the transmission ratio between the drive pulley and the driven, whereby the engine tends to remain at a given speed of operation. As shown in FIG. 1, a clutch assembly 24, the operation of which can be summarized as follows, is interposed between the driven pulley 13 and the hub 23 (of a wheel, not shown).

A cap 25, which is dragged into rotation by the shaft 21, is keyed on the shaft 21 of the driven pulley 13. The cap 25 is further equipped with a plurality of shoes 26 (variable in number according to requirements and/or circumstances), said shoes 26 being radially translatable outwards by virtue of the bias of the centrifugal force generated by the rotation of the cap 25. The progressive translation of the shoes 26 towards the outside of the cap 25 results in the progressive engagement of the bell 27 by the shoes 26 and thus in the mutual coupling of the cap 25 and of the bell 27, which is then dragged into rotation, where the rotation of the bell 27 results in the rotation of the shaft 23, and thus of the wheel.

Obviously, as the rpm of the engine 10, and thus of the pulley 13 and of the cap 25, decreases, the shoes 26 retract and decoupling of the bell 27 from the cap 25, and ultimately decoupling of the shaft 23 from the transmission and from the engine 10, occurs.

The described clutch, being of the centrifugal type present in the driven pulley, allows disconnecting the engine automatically from the wheel when the engine is running at a speed close to idling speed and making it integral when rotation speed increases and thus avoids the need for a clutch lever, as it adheres to the clutch bell when a given rotation speed of the driven pulley is achieved.

Transmission-clutch systems or clutch assemblies of the described type, although appreciable from various points of view, including high reliability and simplicity of construction and of use, are not free from drawbacks and/or disadvantages that the present disclosure intends to overcome.

A drawback relates to the fact that it is not possible to put the hub 23 and the respective wheel into rotation in the opposite direction and to reverse the vehicle with the engine off or idling. Even assuming one were to put the drive shaft 11 in reverse rotation, e.g. by using (through a suitable inverter) the motive energy of the current generator, the low speeds would not allow the masses (the shoes 26) of the clutch normally used, to expand and transmit the motion from the transmission to the wheel, according to the methods described above. If the shoes 26 of the clutch 24 do not reach the rotational speed needed to expand, and to couple to the clutch bell 25, the rotation of the drive shaft 11 does not transmit motion to the wheel because wheel and transmission are not mutually coupled. As this condition occurs when the drive shaft 11 is put into reverse rotation by using the current generator as a motive force by putting the rotor fixed to the drive shaft into rotation, it explains why the vehicle cannot be reversed.

Another drawback relates to the fact that with the engine off, and thus in decoupling condition between transmission and wheel, it is not possible to push-start the engine (e.g. in the case of flat battery), since the wheel rotation generated by the push is not transmitted to the engine.

### SUMMARY OF THE INVENTION

An object of the present invention is to overcome or at least minimize the drawbacks found in the solutions according to the prior art, in particular those summarized above with reference to FIG. 1.

Another object of the present invention is to suggest and provide a solution which allows reversing the vehicle with the engine off and/or push-starting the engine, e.g. in case of flat battery and/or of fault in the electrical system.

Furthermore, according to the present disclosure, the above objects are achieved by using a small number of component parts of simple construction which can be manufactured and assembled at low cost.

The present disclosure is based on the general consideration that the vehicle can be reversed with the engine off and the engine can be push-started by a solution which allows:
mutual automatic constraint between drive shaft and wheel with the engine off or running at very slow speed, either close to or slower than idle speed (idling speed being intended as the minimum turning speed useful to keep the engine running), both in case of reverse rotation of the drive shaft and in case of rotation of the wheel in the travel direction, e.g. generated by pushing; and
mutual automatic release, with the engine on and at rpm sufficient to start the vehicle.

The present disclosure relates to a clutch assembly, in particular for motorcycles, said clutch assembly comprising a bell adapted to be engaged and disengaged alternatively by a rotating transmission component, wherein mutual engagement of said bell and said rotating transmission component by at least one first engagement element results in said bell being dragged in rotation by said transmission component in a first rotation direction, wherein said bell defines an engagement profile formed so as to be engaged and disengaged alternatively by at least one second engagement element dragged in rotation by said transmission component, and wherein the mutual engagement of said at least one second engagement element and said engagement profile is achieved as a result of both the rotation of said transmission component in a second rotation direction, opposite to said first rotation direction, and the rotation of said bell in said first rotation direction, whereas the mutual disengagement of said at least one second engagement element and said engagement profile is achieved as a result of both the rotation of said transmission component in said first rotation direction opposite to said second rotation direction, and the rotation of said bell in said second rotation direction.

According to an embodiment, said bell comprises a cylindrical portion, where the engagement profile is defined by at least one portion of the outer surface of said cylindrical portion.

According to an embodiment, said cylindrical portion of said bell comprises at least one depression with respect to a cylindrical reference surface, said depression being subtended by a predefined angular sector centred on the longitudinal axis of said cylindrical portion.

According to an embodiment, the outer surface of said at least one depression is the locus of the generatrix half-lines parallel to the longitudinal axis of said cylindrical portion.

According to an embodiment, the distance of said generatrix half-lines from said longitudinal axis of said cylindrical portion varies within said angular sector.

According to an embodiment, the distance of said generatrix half-lines from said longitudinal axis of said cylindrical portion varies continuously within said angular sector.

According to an embodiment, said angular sector comprises a first subsector and a second subsector, wherein in the second subsector the curve defined by the intersection between a plane perpendicular to the longitudinal axis of said cylindrical portion and the external surface of said at least one depression comprises at least one concavity faced towards said cylindrical reference surface.

According to an embodiment, in said first subsector the curve defined by the intersection between a plane perpendicular to the longitudinal axis of said cylindrical portion and the external surface of said at least one depression comprises at least one convexity faced towards said cylindrical reference surface.

According to an embodiment, said at least one concavity and said at least one convexity are connected in a continuous manner.

The present disclosure further relates to a transmission system, in particular for motorcycles, said system comprising a rotating transmission component, at least one first engagement element and at least one second engagement element and a bell adapted to be engaged and disengaged alternatively by said rotating transmission component, wherein mutual engagement of said bell and said rotating transmission component by the at least one first engagement element results in said bell being dragged in rotation by said transmission component in a first rotation direction, wherein said bell is a bell according to one of the preceding embodiments, and wherein mutual engagement of said at least one second engagement element and said engagement profile is a result of both the rotation of said transmission component in a second rotation direction opposite to the said first rotation direction, and the rotation of said bell in said first rotation direction, whereas the mutual disengagement of said at least one second engagement element and said engagement profile is a result of both the rotation of said transmission component in said first rotation direction, opposite to said second rotation direction, and the rotation of the bell in said second rotation direction.

According to an embodiment, said transmission system, comprises a first pulley positioned outside said bell, wherein said at least one second engagement element comprises at least one pawl fixed to said first pulley and adapted to be switched between a first engagement position where it engages said at least one depression and a second disengagement position in which it is disengaged from said at least one depression, and where the switching of said at least one pawl from said first engagement position to said second disengagement position is a result of both the rotation of said first pulley in said first rotation direction, and the rotation of said bell in said second rotation direction.

According to an embodiment, said at least one pawl is constrained to said first pulley so that it can be switched by rotation, where both the rotation of said first pulley in said first rotation direction, and the rotation of said bell in said second rotation direction result in said at least one pawl being put into rotation in a first own rotation direction and thus in it being switched from said first engagement position to said second disengagement position.

According to an embodiment, said system comprises at least one first elastic element interposed between said pulley and said at least one pawl, wherein said at least one pawl is switched by rotation, in particular by centrifugal force of said at least one pawl from said first engagement position to said second disengagement position against the elastic resistance applied by said at least one first elastic element, whereas said at least one pawl is switched by rotation from said second disengagement position to said first engagement position by virtue of the thrusting action applied by said at least one first elastic element. According to an embodiment, said rotating transmission component comprises a second pulley or cap equipped with said at least one first engagement element, said at least one first engagement element comprising a plurality of back-pushing and/or engaging shoes at least partially housed inside said bell, wherein said shoes are adapted to be translated along a radial direction, and wherein the rotation of said rotating component in said first rotation direction results in said shoes being radially translated, and thus in the mutual engagement of said second pulley and of said bell, and thus in said bell being dragged in rotation by said rotating transmission component.

According to an embodiment, said system comprises a continuously variable transmission (CVT), wherein said rotating transmission component belongs to the driven rotating component of said continuously variable transmission.

The present disclosure will become apparent from the following detailed description of the embodiments shown in the drawings. However, the present disclosure is not limited to the embodiments described hereinafter and shown in the drawings. Modifications and other variants of the embodiments described below, that may be apparent to a person skilled in the art, are intended to be included within the scope of the present disclosure.

### BRIEF DESCRIPTION OF THE DRAWINGS

FIG. 1 shows a diagrammatic view of a transmission-clutch system according to the prior art;

FIG. 2 shows a perspective view of part of a transmission-clutch system according to an embodiment of the present disclosure;

FIG. 3 shows a side view of a rotating part of a transmission-clutch system according to an embodiment of the present disclosure;

FIG. 4 shows a perspective view of part of a system according to an embodiment of the present disclosure;

FIG. 5 shows a perspective view of a system according to an embodiment of the present disclosure; and

FIG. 6 shows a diagrammatic view of constructional details of a system to an embodiment of the present disclosure.

### DETAILED DESCRIPTION

The present invention is advantageously applied in case of transmission ratio automatic variation and/or continuous transmission systems, in particular in the case of CVTs. For this reason, hereinafter, the present disclosure will be explained with reference to its applications to continuously variable transmissions (CVTs). It is further worth noting that possible applications of the present disclosure are not limited to continuously variable transmissions (CVTs), but include transmission systems of any kind.

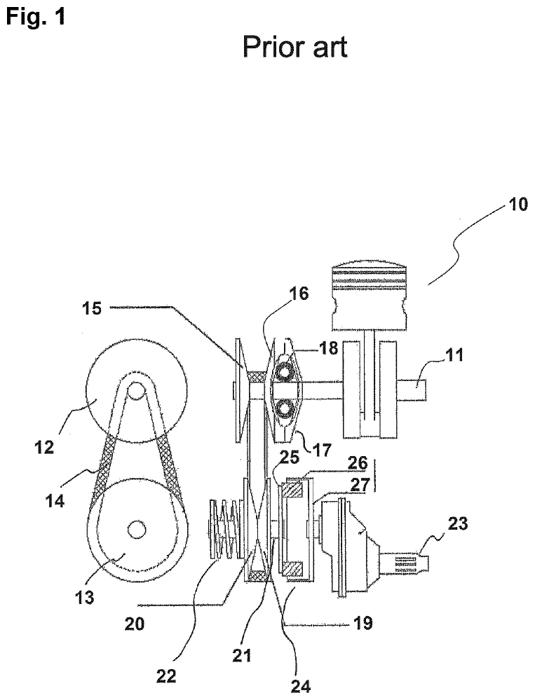

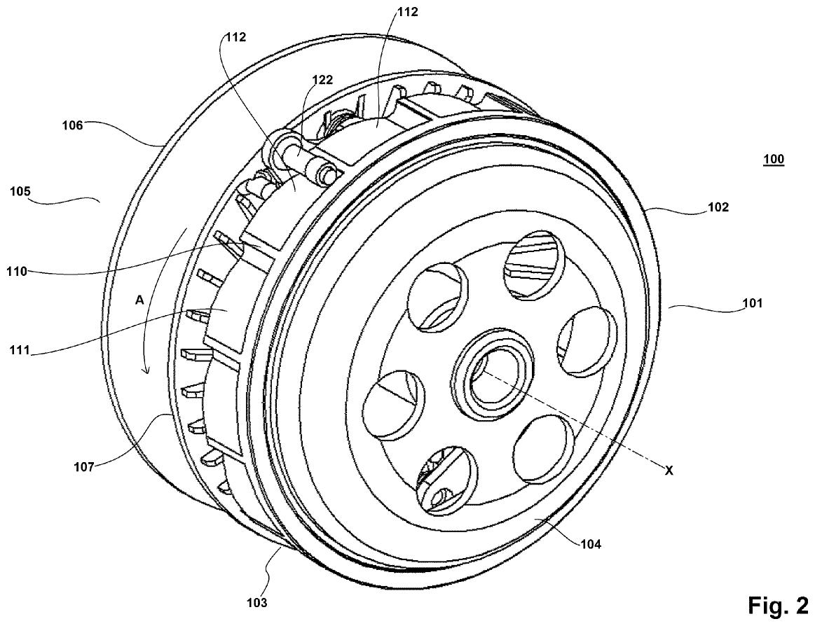

In FIG. 2, reference numeral 100 identifies a transmission-clutch system according to an embodiment of the present disclosure, where, for clarity reasons, only the parts essential for describing the system are shown. Reference numeral 101 identifies a clutch, said clutch 101 comprising a bell 102, which comprises a cylindrical portion 103 extending from a flange 104 to which a wheel hub can be connected by means of a gear final reduction, according to substantially known methods (see the description of FIG. 1). Moreover, in FIG. 2, reference numeral 105 identifies a driven pulley, in turn comprising a movable half-pulley 106 (again according to the methods described above) and a fixed half-pulley 107.

According to substantially known methods, a cap integral in rotation with the half-pulley 107 is housed in the inner space defined by the cylindrical portion 103 of the bell 102 positioned facing the half-pulley 107, said cap (not shown in the figure) being equipped with back-pushing and/or engagement shoes (first engagement element) radially translatable (expandable) as a consequence of the centrifugal force generated by the rotation of the fixed half-pulley 107 and of the cap housed in the cylindrical portion 103 of the bell 102.

Assuming, for clarity purposes, that the half-pulley 107 is put into rotation by the vehicle engine in the rotation direction indicated by the arrow A, and that the rotation direction indicated by the arrow A corresponds to the forward direction of the vehicle, the rotation of the half-pulley 107 in the direction of the arrow A, and therefore of the cap housed in the bell, with sufficient rotation speed, results in the engagement of the bell 102 by the expandable shoes, and thus in the rotation of the bell 102 in the same rotation direction A, and finally in rotation of the wheel hub and of the wheel itself in the same rotation direction A.

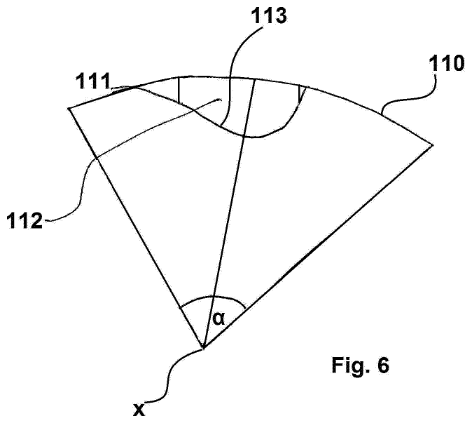

Furthermore, the bell 102 has innovative features, as described below in detail with reference to FIGS. 2 and 6.

As shown in the figures, with respect to a substantially cylindrical reference surface 110, the outer surface 111 of the cylindrical portion 103 comprises mutually contiguous recesses 112, each subtended by an angular sector a centred on the longitudinal symmetry axis X of the cylindrical portion 103. The surface of each depression 112 may be defined as the locus of the generatrix half-lines parallel to the X axis, where the distance of said generating lines from the X axis varies as a function of the angular position, in particular from a maximum corresponding to the radius of the reference surface 110 at the opposite ends of the angular sector u, to a minimum in intermediate position between the two extremes, where the minimum distance of the directrix of the X axis naturally corresponds to the maximum depth of the depression 112. Furthermore, the curvature of the outer surface 111 of each depression 112 is such that the curve defined by the intersection of the surface 111 with a reference plane perpendicular to the X axis (and therefore parallel to the plane of FIG. 6) is such as to comprise a concavity C1 facing towards the reference surface 110 on a first sub-sector al, and a convexity C2 facing towards the reference surface 110 in a second sub-sector u2 of the angular sector u, where also the convexity C2 and the concavity C1 are joined continuously.

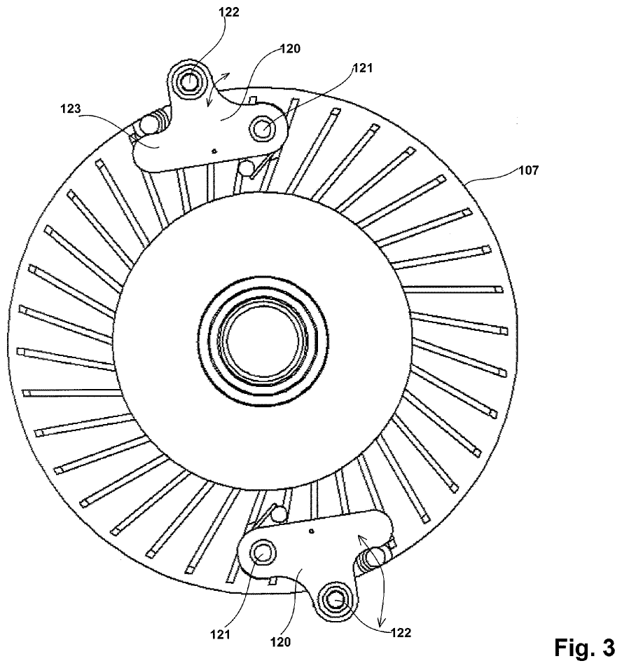

Further aspects of the present disclosure may be appreciated with reference to FIGS. 2 and 3, showing two second engagement elements 120 applied on the driven half-pulley 107, and in particular on its inner face facing towards the bell 102. The number of the engagement elements may vary from a minimum of one to a maximum corresponding to the number of depressions 112, according to requirements and/or circumstances. Each element 120 comprises a plate 123 parallel to the half-pulley 107 and interposed between the pulley 107 and the bell 102, the plate 123 being positioned outside the bell 102. The plate 123 is rotatably constrained to the half-pulley 107 by a constraint or pin 121, the plate 123 being switchable by rotation about the pin 121 in the two opposite rotation directions indicated by the double arrow in FIG. 3. A cylindrical pawl 122 extends from the plate 123, in a direction transversal to the plate 123 and parallel to the axis X of the cylindrical portion 103 of the bell 102, said pawl 122 extending from the plate 123 so as to be positioned above the outer surface 111 of said cylindrical portion 103. Elastic back-pulling means, e.g. a spring, are interposed between the plate 123 and the half-pulley 107. The switch by rotation of the element 120 in a first rotation direction towards the outside and thus with the pawl 122 away from the surface 111 occurs against the elastic bias applied by the spring, while the switch for rotation of the element 120 in a second rotation direction opposite to the first one, in particular towards the inside and thus with the pawl 122 approaching towards the surface 111 is promoted by the elastic reaction of the spring itself.

The operation of the system according to the embodiment of the present disclosure described above can be summarized as follows.

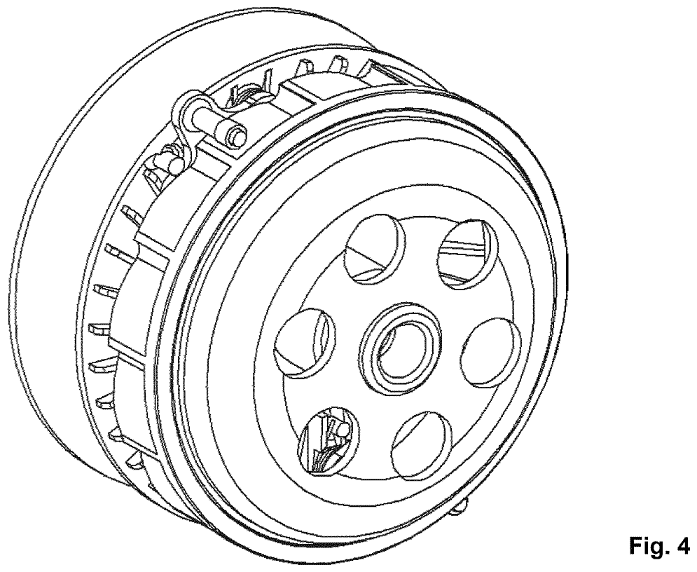

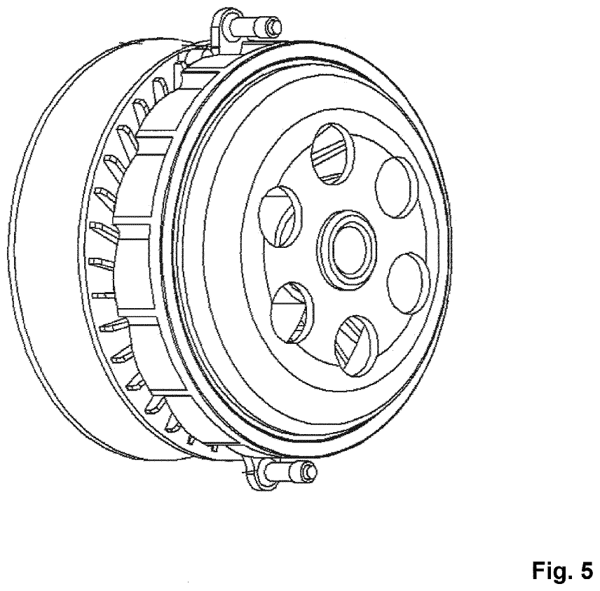

FIG. 2 shows a first configuration in which each one of the pawls 122, by virtue of the action of the respective spring, is pushed against the surface 111 and engages a corresponding depression 112, being housed in the concavity C1 of the depression itself. In this configuration, a possible rotation of the bell 102 in the rotation direction A shown in FIG. 2 results into dragging into rotation the driven pulley 105. Assuming a situation in which the engine is off, the pads inside the bell 102 are in the retracted position and the bell 102 is released from the cap, so that any rotation of the bell 102 would not result in rotation of the driven pulley 105, by virtue of the engagement of the elements 120 on the surface 111 of the bell 102, the rotation of the bell 102 results in the rotation respectively of the pulley 105, of the driving pulley, and thus of the drive shaft, allowing starting the engine itself, if, for example, the rotation of the bell 102 is caused by pushing the vehicle. The configuration in FIG. 2 does not hinder the normal operation of the vehicle, in particular of the transmission of the vehicle itself, in any manner. Indeed, assuming that the pulley 105 is put into rotation in rotation direction A by starting the engine and then through the transmission (drive pulley, belt etc.), the rotation of the half-pulley 107 in the rotation direction A results in putting into rotation the bell 102 in an entirely normal manner, rather than by action of the engagement elements 120 on the bell, during coupling between the bell 102 and the half-pulley 107 deriving from the expansion of the shoes housed inside the bell 102 and by virtue of the dragging action applied by the shoes on the inner surface of the cylindrical portion 103 of the bell 102. The pawls 122 are instead switched to the disengagement configuration (FIGS. 4 and 5) as a result of both the thrust action applied on each pawl 122 of the assembly C2 of the respective depression 122 and of the centrifugal force, where the pawls 122 are rotated away from the outer surface 111 and disengaged from the respective depressions 122.

A further use of the system according to the present invention can finally be summarized as follows.

Assuming the driven pulley 105 is put into rotation in the rotation direction opposite to the rotation direction A shown in FIG. 2, that is, when the engine is off or running at a very slow speed, either close to or lower than idling speed (and thus in disengagement condition between the bell 102 and the pads inside it, the pads being in retracted position), and, for example, the drive force generated by the alternator to the drive shaft is applied, by virtue of the engagement of the pawls 122 in the respective depressions 112, the bell 102 is also dragged into rotation in the rotation direction opposite to the rotation direction A, where the hub applied to the bell 102 and the wheel are put into rotation in the rotation direction contrary to the forward travel rotation direction, thus allowing to reverse the vehicle, for instance, by exploiting the contrary rotation on the drive shaft.

The present disclosure provides a solution which allows both reversing the vehicle with engine off or running at a very slow rpm, close to idling, and/or push-starting the engine, that is, in case of flat battery and/or of fault in the electrical system.

Moreover, the aforesaid objects are achieved by using a limited number of component parts of simple construction which can be manufactured at a low cost.

The present disclosure is not limited to the embodiments described above and shown in the drawings. Embodiments and constructional details may be modified with respect to those described herein by way of non-limiting examples, without thereby departing from the scope of protection as described and claimed herein.

1. A clutch said clutch comprising a bell adapted to be engaged and disengaged alternatively by a rotating transmission component, wherein mutual engagement of said bell and said rotating transmission component by at least one first engagement element results in said bell being dragged in rotation by said transmission component in a first rotation direction (A), wherein said bell defines an engagement profile formed so as to be engaged and disengaged alternatively by at least one second engagement element dragged in rotation by said transmission component, and wherein the mutual engagement of said at least one second engagement element and said engagement profile is a result of both the rotation of said transmission component in a second rotation direction, opposite to said first rotation direction (A), and the rotation of said bell in said first rotation direction (A), whereas mutual disengagement of said at least one second engagement element and said engagement profile is a result of both the rotation of said transmission component in said first rotation direction (A) opposite to said second rotation direction, and the rotation of said bell in said second rotation direction.

2. The clutch of claim 1, wherein said bell comprises a cylindrical portion and said engagement profile is defined by at least one portion of an outer surface of said cylindrical portion.

3. The clutch of claim 2, wherein said cylindrical portion of said bell comprises at least one depression with respect to a cylindrical reference surface, said depression being subtended by a predefined angular sector (α) centred on a longitudinal axis of said cylindrical portion.

4. The clutch of claim 3, wherein the outer surface of said at least one depression is the locus of generatrix half-lines parallel to the longitudinal axis of said cylindrical portion.

5. The clutch of claim 4, wherein the distance of said generatrix half-lines from said longitudinal axis of said cylindrical portion varies within said angular sector (α).

6. The clutch of claim 5, wherein the distance of said generatrix half-lines from said longitudinal axis of said cylindrical portion varies continuously within said angular sector (α).

7. The clutch of claim 5, wherein said angular sector (α) comprises a first subsector (α1) and a second subsector (α2), and wherein in the first subsector (α1) a curve defined by an intersection between a plane perpendicular to the longitudinal axis of said cylindrical portion and the outer surface of said at least one depression comprises at least one concavity faced towards said cylindrical reference surface.

8. The clutch of claim 7, wherein in said second subsector (α2) the curve defined by the intersection between a plane perpendicular to the longitudinal axis of said cylindrical portion and said outer surface of said at least one depression comprises at least one convexity faced towards said cylindrical reference surface.

9. The clutch of claim 8, wherein said at least one concavity and said at least one convexity are connected in a continuous manner.

10. A transmission system comprising a rotating transmission component, at least one first engagement element and at least one second engagement element and a bell adapted to be engaged and disengaged alternatively by said rotating transmission component, wherein mutual engagement of said bell and said rotating transmission component by said at least one first engagement element results in said bell being dragged in rotation by said transmission component in a first rotation direction, and wherein mutual engagement of said at least one second engagement element and said engagement profile is a result of both the rotation of said transmission component in a second rotation direction opposite to the said first rotation direction (A), and the rotation of said bell in said first rotation direction (A), whereas mutual disengagement of said second at least one engagement element and said engagement profile is a result of both the rotation of said transmission component in said first rotation direction (A), opposite to said second rotation direction, and the rotation of the bell in said second rotation direction.

11. The transmission system of claim 10, wherein said transmission component comprises a first pulley positioned outside of said bell, wherein said at least one second engagement element comprises at least one pawl fixed to said first pulley and adapted to be switched between a first engagement position wherein it engages said at least one depression and a second disengagement position in which it is disengaged from said at least one depression, and wherein switching of said at least one pawl from said first engagement position to said second disengagement position is a result of both the rotation of said first pulley in said first rotation direction (A), and the rotation of said bell in said second rotation direction.

12. The transmission system of claim 11, wherein said at least one pawl is constrained to said first pulley so that it can be switched by rotation, and wherein both the rotation of said first pulley in said first rotation direction (A), and the rotation of said bell in said second rotation direction, result in said at least one pawl being rotated in a first own rotation direction and being switched from said first engagement position to said second disengagement position.

13. The transmission system of claim 12, wherein said system comprises at least one first elastic element interposed between said pulley and said at least one pawl, and wherein said at least one pawl is switched by rotation from said first engagement position to said second disengagement position against the elastic resistance exerted by said at least one first elastic element, whereas said at least one pawl is switched by rotation from said second disengagement position to said first engagement position due to the thrusting action exerted by said at least one first elastic element.

14. The transmission system (100) of claim 10, wherein said rotating transmission component comprises a second pulley or cap equipped with said at least one first engagement element, said at least one first engagement element comprising a plurality of back-pushing and/or engaging shoes at least partially housed inside said bell, wherein each of said plurality of shoes is adapted to be translated along a radial direction, and wherein rotation of said rotating component in said first rotation direction (A) results in said plurality of shoes being radially translated, in the mutual engagement of said second pulley or distributor cap and said bell, and in said bell being dragged in rotation by said rotating transmission component.

15. The transmission system of claim 10, wherein said system comprises a continuously variable transmission (CVT), and wherein said rotating transmission component belongs to a driven rotating component of said continuously variable transmission.
